(19) United States
(12) Patent Application Publication
(10) Pub. No.: US 2025/0018826 A1
(43) Pub. Date: Jan. 16, 2025

(54) ENERGY DISSIPATION ACTIVATION AND MANAGEMENT SYSTEMS AND METHODS FOR VEHICLES

(71) Applicant: GM Global Technology Operations LLC, Detroit, MI (US)

(72) Inventors: Yu CAO, Courtice, CA (US); Priya Kikani, Ferndale, MI (US); Todd P. Lindemann, Brighton, MI (US); Jordan Syrowik, Grand Blanc, MI (US); Sean Edward Zuzga, Farmington Hills, MI (US); David B. Antanaitis, Northville, MI (US)

(21) Appl. No.: 18/352,069

(22) Filed: Jul. 13, 2023

(51) Int. Cl. B60L 58/10; B60L 15/20

(52) U.S. Cl. CPC B60L 58/10; B60L 15/2009

(57) ABSTRACT

An energy dissipation activation management (EDAM) system for a vehicle includes at least one requestor system, at least one dissipator system, and an EDAM module. The at least one requestor system is configured to generate a request to burn energy stored in at least one battery pack of the vehicle. The at least one dissipator system is configured to burn energy stored in the at least one battery pack. The EDAM module is configured to receive the request, determine a status of the at least one requestor system, and based on the request and the status of the at least one requestor system, signal the at least one dissipator system to burn energy stored in the at least one battery pack.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to energy management systems of vehicles.

Electric vehicles include one or more power sources for supplying electrical energy to one or more electric motors. The electric motors are utilized for propulsion purposes and can also be used to reduce speed of the vehicles and recharge, for example, cells of the power sources. As an example, the electric motors may be operated as generators during regenerative braking operation to decelerate the vehicles and/or recharge the power sources.

### SUMMARY

An energy dissipation activation management (EDAM) system for a vehicle is disclosed and includes: at least one requestor system configured to generate a request to burn energy stored in at least one battery pack of the vehicle; at least one dissipator system configured to burn energy stored in the at least one battery pack; and an EDAM module configured to receive the request, determine a status of the at least one requestor system, and based on the request and the status of the at least one requestor system, signal the at least one dissipator system to burn energy stored in the at least one battery pack.

In other features, the burning of energy is defined as the dissipating of energy by the at least one dissipator system to reduce an amount of energy stored in the at least one battery pack to increase an amount of available storage in the at least one battery pack for energy generated by the at least one requestor system.

In other features, the burning of energy is defined as the dissipating of energy from the at least one battery pack via the at least one dissipator system to increase available energy storage of the at least one battery pack and not to perform another vehicle operation via the at least one dissipator system.

In other features, the at least one requestor system includes at least one of a brake system and a motor control system. The EDAM module is configured to determine a status of at least one of the brake system and the motor control system, and based on the status of the at least one of the brake system and the motor control system, signal the at least one dissipator system to burn energy stored in the at least one battery pack.

In other features, the EDAM module is configured to operate in an auto energy burn mode or a manual energy burn mode.

In other features, the EDAM module is configured to determine whether an override signal has been received, and in response to receiving the override signal, cease operating in an energy burn mode.

In other features, the EDAM module is configured to: determine an amount of energy to dissipate to prevent overheating of a component of the at least one requestor system; based on the determined amount of energy to dissipate, predict whether the component will overheat; and in response to determining that the component is expected to overheat, performing a countermeasure to prevent the component from overheating.

In other features, the EDAM module is configured to determine the status of the at least one requestor system based on a thermal model, and enable operation in an energy burn mode in response to the status.

In other features, the EDAM system further includes an arbitration module. The EDAM module is configured to determine an amount of energy to burn. The at least one dissipator system includes dissipator systems. Each of the dissipator systems generates an energy dissipation capacity signal indicating an amount of energy the corresponding dissipator system is capable of burning. The arbitration module is configured, based on the amount of energy to burn and the energy dissipation capacity signals, determine how much energy each of the dissipator systems is to burn and control each of the dissipator systems to burn that determined amount of energy.

In other features, the EDAM system further includes an arbitration module. The EDAM module is configured to determine an amount of energy to burn. The at least one dissipator system includes dissipator systems. Each of the dissipator systems generating an energy dissipation capacity signal indicating an amount of energy the corresponding dissipator system is capable of burning. The arbitration module is configured, based on the amount of energy to burn and the energy dissipation capacity signals, determine how much energy each of the dissipator systems is to burn and instruct each of the dissipator systems to burn that amount of energy.

In other features, the EDAM system further includes a translation module. The at least one dissipator system includes multiple dissipator systems. The EDAM module is configured to generate a command signal according to a first protocol format and indicative of an amount of energy to burn. The translation module is configured to translate the command signal into commands respectively for the dissipator systems. The commands being in different protocol formats acceptable by the dissipator systems.

In other features, the at least one dissipator system includes multiple dissipator systems. The EDAM module is configured to account for interactions between the dissipator systems, and based on the interactions, determine amounts of energy to be burned by the dissipator systems, and directly or indirectly signal the dissipator systems to burn the determined amounts of energy.

In other features, the EDAM module is configured to perform an iterative calculation to obtain the energy requested to burn.

In other features, the EDAM module is configured to apply a hysteresis condition to prevent frequent switching in and out of an energy burning mode.

In other features, a method of operating an EDAM system of a vehicle is disclosed. The method includes: generating via at least one requestor system a request to burn energy stored in at least one battery pack of the vehicle; burn energy via stored in the at least one battery pack via at least one dissipator system; determining a status of the at least one requestor system; and based on the request and the status of the at least one requestor system, signaling the at least one dissipator system to burn energy stored in the at least one battery pack.

In other features, the method further includes: determining an amount of energy to dissipate to prevent overheating of a component of the at least one requestor system; based on the determined amount of energy to dissipate, predicting whether the component will overheat; and in response to determining that the component is expected to overheat, performing a countermeasure to prevent the component from overheating.

In other features, the method further includes: determining the status of the at least one requestor system based on a thermal model; and enabling operation in an energy burn mode in response to the status.

In other features, the method further includes: determining an amount of energy to burn, where the at least one dissipator system includes multiple dissipator systems; generating via each of the dissipator systems an energy dissipation capacity signal indicating an amount of energy the corresponding dissipator system is capable of burning; and based on the amount of energy to burn and the energy dissipation capacity signals, determining how much energy each of the dissipator systems is to burn and controlling each of the dissipator systems to burn that determined amount of energy.

In other features, the method further includes: determining an amount of energy to burn, where the at least one dissipator system includes multiple dissipator systems; generating via each of the dissipator systems an energy dissipation capacity signal indicating an amount of energy the corresponding dissipator system is capable of burning; and based on the amount of energy to burn and the energy dissipation capacity signals, determining how much energy each of the dissipator systems is to burn and instructing each of the dissipator systems to burn that amount of energy.

In other features, the method further includes: generating a command signal according to a first protocol format and indicative of an amount of energy to burn; translating the command signal into commands respectively for multiple dissipator systems, the commands being in different protocol formats acceptable by the dissipator systems, where the at least one dissipator system includes the dissipator systems; accounting for interactions between the dissipator systems; and based on the interactions, determining amounts of energy to be burned by the dissipator systems, and directly or indirectly signaling the dissipator systems to burn the determined amounts of energy.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example vehicle including an energy dissipation system with an EDAM module in accordance with the present disclosure;

FIG. 2 is a functional block diagram of an example portion of the energy dissipation system of FIG. 1 illustrating information collection, generation, transfer, arbitration, translation and feedback control in accordance with the present disclosure;

FIG. 3 illustrates an example EDAM method in accordance with the present disclosure; and

FIG. 4 illustrates an example method for energy dissipation (or energy burn (eBurn)) enablement and disablement in accordance with the present disclosure.

In the drawings, reference numbers may be reused to identify similar and/or identical elements.

### DETAILED DESCRIPTION

During a downhill descent, such as when traveling down a mountain, brakes of a vehicle can overheat if thermal energy of the brakes is not dissipated or captured. Overheating can especially occur in heavy duty trucks having large payloads and/or in vehicles pulling a trailer. Regenerative braking may be implemented to capture and convert the thermal and/or rotational energy to electrical energy. Regenerative braking may occur in a braking system and/or via one or more motors of the vehicle. The electrical energy may be stored, for example, in one or more battery packs. Depending on the state of charge (SOC) of the batter packs, the battery packs may not be able to store extra energy to maintain the temperature of the brakes and/or the motors within a safe operating range (e.g., less than 500° F. or other temperature threshold).

The examples set forth herein enable energy dissipation from one or more battery packs and/or other electrical energy sources to provide increased storage space for electrical energy generated due to regenerative braking. A braking system may, for example, request electrical energy dissipation and an EDAM module, as disclosed herein, may control operation of one or more other vehicle systems and/or devices to dissipate the requested electrical energy. Increased storage space may also or alternatively be provided to increase storage space for electrical energy generated by another system requesting energy dissipation. The one or more vehicle systems may include a battery electric vehicle (BEV) heating, ventilation, and air-conditioning (HVAC) system, a motor control system, a fuel cell system, and/or other energy dissipation system. The examples disclosed herein include a control architecture including a requestor and dissipator layer and a management layer. The requestor and dissipator layer includes i) one or more systems requesting energy dissipation, and ii) one or more systems dissipating energy. The management layer determines how much energy the selected systems are to dissipate and command the selected systems to dissipate the requested amount of energy.

The examples include engagement and disengagement of an energy dissipation (or eBurn) mode during which one or more systems are dissipating electrical energy. When engaged, the electrical energy is being dissipated to increase storage space of electrical energy for the system(s) requesting energy dissipation. As an example, a braking system may request energy dissipation and one or more other systems may dissipate electrical energy to allow a motor to perform regenerative braking and maintain brake temperatures below predetermined thresholds.

The examples further include an algorithm to calculate a total amount of energy dissipation requested from one or more systems. Vehicle status and location is monitored and predicted, and braking system (or requestor) parameters are monitored and predicted. Overheat prediction is used as an example trigger to enable the eBurn mode. The EDAM module collects dissipation requests from different systems, arbitrates the requests based on a predetermined ranking, and generates energy dissipation commands for the one or more systems to perform energy dissipation.

The eBurn mode may be engaged and disengaged automatically via the EDAM module or may be manually engaged and disengaged by, for example, a driver of the corresponding vehicle. The driver may override operation in the eBurn mode, as further described below.

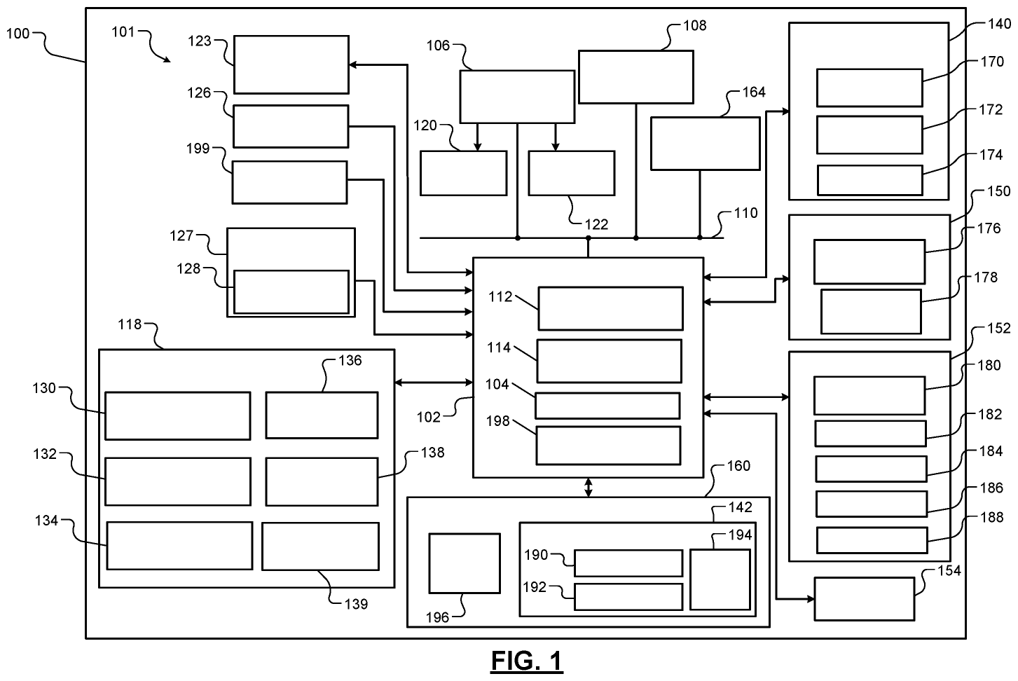

FIG. 1 shows a vehicle 100, which includes an EDAM system 101 for activating and managing dissipation of electrical energy via systems of the vehicle 100. The phrase “burning of energy” may be refer to the dissipation of energy by the at least one dissipator system to reduce an amount of energy stored in the at least one battery pack. This may be done to increase an amount of available storage in the at least one battery pack for energy generated by the at least one requestor system. The burning of energy may further be defined as the dissipating of energy from the at least one battery pack via the at least one dissipator system to increase available energy storage of the at least one battery pack and not to perform another vehicle operation via the at least one dissipator system.

The vehicle 100 includes a vehicle control module 102, which includes an EDAM module 104 for controlling activation, deactivation, and management of energy dissipation. The vehicle 100 may further include an infotainment module 106 and other control modules 108. The modules 102, 104, 106, 108 may communicate with each other via one or more buses 110, such as a controller area network (CAN) bus and/or other suitable interfaces. The vehicle control module 102 may control operation of vehicles systems and include a mode selection module 112, a parameter adjustment module 114, as well as other modules. The EDAM module 104 and/or the mode selection module 112 may select a vehicle operating mode. The modules 104, 112, 114 may adjust various parameters of the vehicle 100.

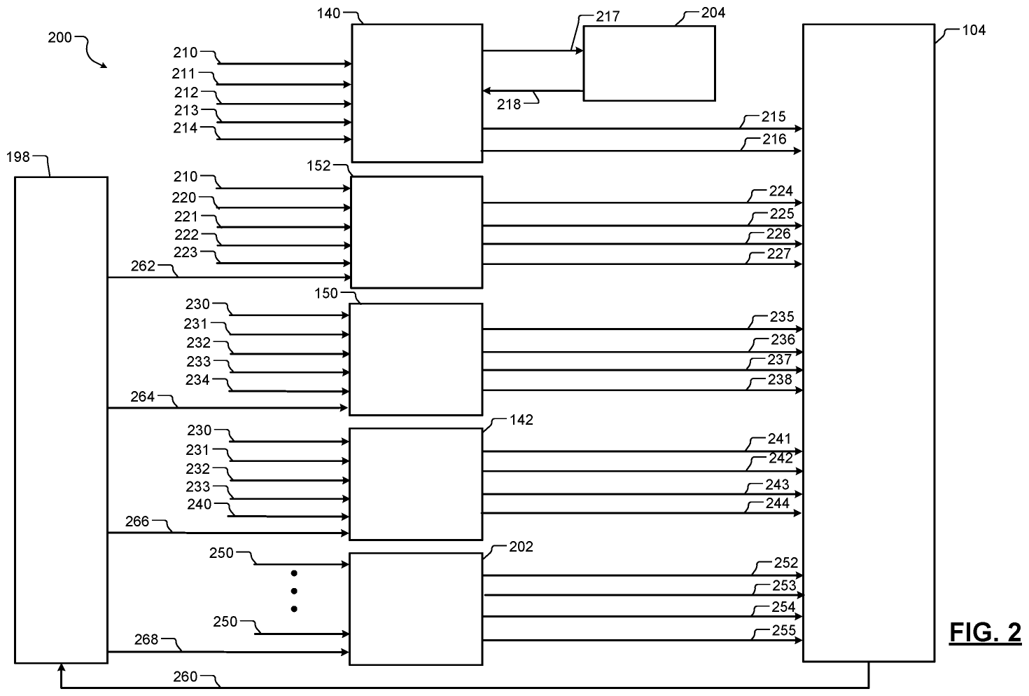

The vehicle 100 may further include: a memory 118; a display 120; an audio system 122; one or more transceivers 123 including sensors 126; and a navigation system 127 including a global positioning system (GPS) receiver 128. The sensors 126 may include: temperature sensors; pressure sensors; power, voltage and current sensors; accelerometers; a vehicle velocity and/or speed sensor; and/or other sensors, such as that referred to with respect to FIG. 2. Some of the temperature and pressure sensors may detect temperatures and pressures in a brake system 140 and fuel cell system 142. The GPS receiver 128 may provide vehicle velocity and/or direction (or heading) of the vehicle and/or global clock timing information.

The memory 118 may store sensor data 130, EDAM algorithms 132, an energy assist application 134, other applications 136, parameters 138, and thermal models 139. The applications 136 may include applications executed by the modules 102, 104, 106, 108. Although the memory 118 and the vehicle control module 102 are shown as separate devices, the memory 118 and the vehicle control module 102 may be implemented as a single device. Also, the vehicle control module 102 may be implemented as one or more control modules.

The vehicle control module 102 and/or the EDAM module 104 may control operation of the brake system 140, a motor control system 150, a BEV HVAC system 152, a steering system 154, and the fuel cell system 142 according to and/or based on parameters set by the modules 102, 104, 106, 108. The vehicle control module 102 may set some of the parameters based on signals received from the sensors 126. The vehicle control module 102 may receive power from one or more power sources 160, which may be provided to the brake system 140, the motor control system 150, the BEV HVAC system 152, the steering system 154, etc. Some of the vehicle control operations may include powering any of the systems 140, 150, 152, 154, and/or performing other operations as are further described herein. The vehicle control module 102 may autonomously control operation of the vehicle 100 including controlling the stated systems 140, 150, 152, 154.

The brake system 140 and the steering system 154 may include actuators controlled by the vehicle control module 102. Other actuators may also be included, such as an accelerator pedal actuator 164. The vehicle control module 102 may control these actuators to, for example, adjust steering wheel angle, accelerator pedal position, brake pressure, etc. This control may be based on the outputs of the sensors 126, the navigation system 127, the GPS receiver 128 and the above-stated data and information stored in the memory 118.

The brake system 140 may include a brake control module 170, brake actuators 172, and brakes 174. The brakes 174 include brake calipers, rotors and pads. The motor control system 150 may include a motor control module 176 and one or more motors 178, which may be used for propulsion purposes and/or for regenerative braking purposes. The BEV HVAC system may include a HVAC control module 180, one or more heaters 182, one or more compressors 184, one or more fans 186, and one or more motors 188. As an example, the fans 186 may be centrifugal type fans.

The power sources 160 may include battery packs 196 and the fuel cell system 142. The fuel cell system 142 may include a compressor 190, a bypass valve 192, and a stack 194. Some of the sensors 126 may be located on or in the battery packs 196 and used to detect the SOCs of the battery packs 196 and/or battery cells therein.

During the eBurn mode, and as an example, the EDAM module 104 may control the motor control system 150, the BEV HVAC system 152, the fuel cell system 142, and/or one or more other systems and devices to burn energy. As an example, a motor may be operated inefficiently to burn additional energy. The motor may be run for propulsion purposes and when in the eBurn mode may be operated inefficiently to provide the same output torque as when not in the eBurn mode and run efficiently. The motor control module 176 may adjust the flux current and/or frequency of the motors 178 when adjusting the operating efficiency of the motors 178. The motor current may be adjusted to generate a same amount of output torque but inefficiently by generating heat with the motors 178. As a result, more power is used to output a same amount of torque.

As another example, the vehicle control module 102 and/or the EDAM module 104 run the fuel cell system 142 in a load shedding mode including adjusting a position of the bypass valve 192 to direct air outside the vehicle 100 instead of across a stack 194 of the fuel cell system 142. This bypasses the stack 194. The EDAM module 104 may thus spool off the compressor 190 to burn energy. As an example, the compressor 190 may burn 14 kilowatts (KW) of power. The time to ramp up the compressor 190 is accounted for and the EDAM module 104 may utilize the fuel cell system 142 for burning energy when the situation arises that has associated time to spool up the compressor 190. This is an example of a dissipation system with a long ramp up period. Other dissipation systems and/or devices may be used to burn energy when a short (or shorter) ramp up period is warranted.

The vehicle control module 102 may include an arbitration and translation module 198. The arbitration and translation module 198 may receive a mode command and a power command from the EDAM module 104. The mode command may indicate whether to operate in the eBurn mode. The power command may indicate an amount of energy to dissipate. The EDAM module 104 and/or the arbitration and translation module 198 may then determine based on dissipation (or energy burning) capacities of systems and devices of the vehicle 100, which systems and devices to dissipate energy and how much energy to be dissipated by the selected systems and devices. This may be determined by the EDAM module 104 and sent to the arbitration and translation module 198 or may be determined by the arbitration and translation module 198. Operations of these modules are further described below.

Each of the systems (e.g., the systems 140, 150, 152, 142) may operate using different protocols. Different protocols may be used to control different actuators of the systems. One of the systems may require reception of a level command (e.g., level 1, Level 2, Level 3, etc.) to indicate how much energy to burn, where each level is associated with a different amount of energy. Another one of the systems may operate based on ON and OFF commands, where the device being controlled in either ON or OFF. Another one of the systems may require an input indicating a current level, a voltage level, a frequency, etc.

The EDAM system 101 may include an eBurn switch 199. In an embodiment, the switch 199 may be in one of three states including i) an auto eBurn state, ii) a manual eBurn enabled state, and iii) a manual eBurn disabled state. As an alternative, the driver may select one of these states via the infotainment module 106.

The following FIG. 2 illustrates and example supervisory control architecture. FIG. 2 shows an example portion 200 of the energy dissipation system 101 of FIG. 1 illustrating information collection, generation, transfer, arbitration, translation and feedback control. Such control collects energy dissipation requests from different requestors, manages the requests at a high level, and distributes and arbitrates the amounts of energy to be dissipated by the systems. This supervisory architecture provides flexibility in adding new energy requestors and energy dissipation systems and devices (or dissipators). Using the supervisory controls architecture, energy dissipation during, for example, a mountain descent is monitored and controlled such that a SOC of a power source is at a maximum level when the vehicle reaches a bottom of the mountain. As an example, the supervisory control may be implemented by the EDAM module 104 and engage the eBurn mode for selected systems concurrently based on a received eBurn request.

As used herein, the SOC of a power source refers to a level of charge of the power source relative to a capacity of the power source. The SOC, for example, of a cell and/or battery pack module may refer to the voltage, current and/or amount of available energy stored in the cell and/or battery pack module. During operation, parameters such as voltage, current, and temperature of battery pack modules (or battery packs) and cells may be monitored to determine SOX values of the battery packs and cells. The acronym “SOX” refers to a state of charge (SOC), a state of health (SOH), state of power (SOP), and/or a state of function (SOF). The SOC of a cell and/or battery pack may refer to the voltage, current and/or amount of available power stored in the cell and/or battery pack. The SOH of a cell and/or battery pack may refer to: the age (or operating hours); whether there is a short circuit; whether there is a loose wire or bad connection; temperatures, voltages, power levels, and/or current levels supplied to or sourced from the cell and/or battery pack during certain operating conditions; and/or other parameters describing the health of the cell and/or battery pack. The SOF of a cell and/or battery pack may refer to a current temperature, voltage, and/or current level supplied to or sourced from the cell and/or battery pack, and/or other parameters describing a current functional state of the cell and/or battery pack. As an example, the SOC and SOH of a cell and/or a battery pack may be monitored to detect a thermal runaway event (TRE).

The portion 200 includes the EDAM module 104, the brake system 140, the BEV HVAC system 152, the motor control system 150, the fuel cell system 142, other requestor and dissipation systems 202, the arbitration and translation module 198, and a driver interface 204. Each of the systems 140, 150, 152, 142, 202 receives respective inputs and has corresponding outputs.

The brake system 140 and/or the brake control module 170 of FIG. 1 receives a battery SOC signal 210, a brake rotor temperature signal 211, a route information signal 212, a driver mode signal 213, and other inputs 214. The brake system 140 and/or the brake control module 170 outputs an energy dissipation mode request signal 215 and a requested dissipation power signal 216. The brake system 140 may further output a driver notification signal 217 and receive a driver override signal 218.

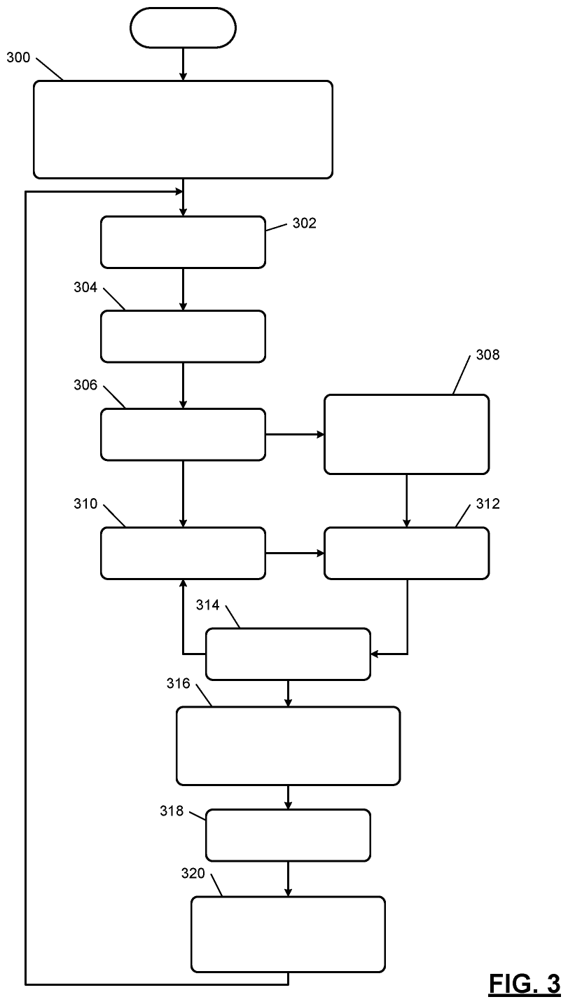

The BEV HVAC system 152 and/or the HVAC control module 180 of FIG. 1 receives the battery SOC signal 210, a battery temperature signal 220, a HVAC settings signal 221, an ambient temperature signal 222, and other inputs 223. The BEV HVAC system 152 and/or the HVAC control module 180 outputs an energy dissipation mode request signal 224, a requested dissipation power signal 225, a real time energy dissipation signal 226, and an energy dissipation capacity signal 227. In an embodiment, not all dissipating systems are able to provide an energy dissipation (ED) capacity signal. For example, the BEV HVAC system 152 may not be configured to generate this signal. As a common communication protocol an ED Mode request signal, a requested dissipation power signal, a real time energy dissipation signal, and an ED capacity signal may be forwarded to the EDAM module 104. As an example, an ED capacity may not be available for the BEV HVAC system 152 and/or may be estimated by the EDAM module 104 based on past data, as defined at 308 in FIG. 3. Other capacities may also be estimated by the EDAM module 104.

The motor control system 150 and/or the motor control module 176 of FIG. 1 receives a motor temperature signal 230, a motor speed signal 231, a regenerative brake request signal 232, a brake pressure signal 233, and other inputs 234. The motor control system 150 and/or the motor control module 176 outputs an energy dissipation mode request signal 235, a requested dissipation power signal 236, a real time energy dissipation signal 237, and an energy dissipation capacity signal 238. The motor control system 150 may perform regenerative braking and request burning of energy similar to the brake system 140. This may be done to prevent one or more motors from overheating during regenerative braking of the one or more motors. The motor control system 150 may also request burning of energy to heat up a motor, for example, in the winter when the vehicle 100 is experiencing cold ambient temperatures.

The fuel cell system 142 receives the motor temperature signal 230, the motor speed signal 231, the regenerative brake request signal 232, the brake pressure signal 233, and other inputs 240, which may be the same or different than the inputs 234. The fuel cell system 142 outputs an energy dissipation mode request signal 241, a requested dissipation power signal 242, a real time energy dissipation signal 243, and an energy dissipation capacity signal 244

The other requestor and dissipation systems 202 receive inputs 250, which may be the same or different than the signals and inputs received by the systems 140, 152, 150, 142. Each of the other requestor and dissipation systems 202 may output respective energy dissipation mode request signals 252, requested dissipation power signals 253, real time energy dissipation signals 254, and energy dissipation capacity signals 255. As an example, one of the other requestor and dissipation systems 202 may be a power source system and may request dissipation of burning of energy to prevent a thermal runaway event in one of the battery packs 196 and/or a cell thereof.

The battery SOC signal 210 may indicate a SOC of each battery pack, battery, and/or cell of the batteries of the battery packs 196 of FIG. 1 and/or an overall SOC collectively of the battery packs 196.

The brake rotor temperature signal 211 may indicate temperatures of brake calipers, of brake rotors, of brake pads, etc. The brake rotor temperature signal 211 may indicate an average temperature of these components. The brake rotor temperature signal 211 may indicate other parameters as a brake system overheat indicator. For example, the time that the brake rotor temperature continuously stays above certain threshold may be indicated, which is indicative of whether a brake system and/or portion thereof is overheating.

The route information signal 212 may indicate a current location of the vehicle 100 of FIG. 1 and/or an expected and/or predicted path of the vehicle 100. This may include expected and/or predicted traveling speeds, road elevations, elevation changes, road incline angles and decline angles, road curvatures, etc.

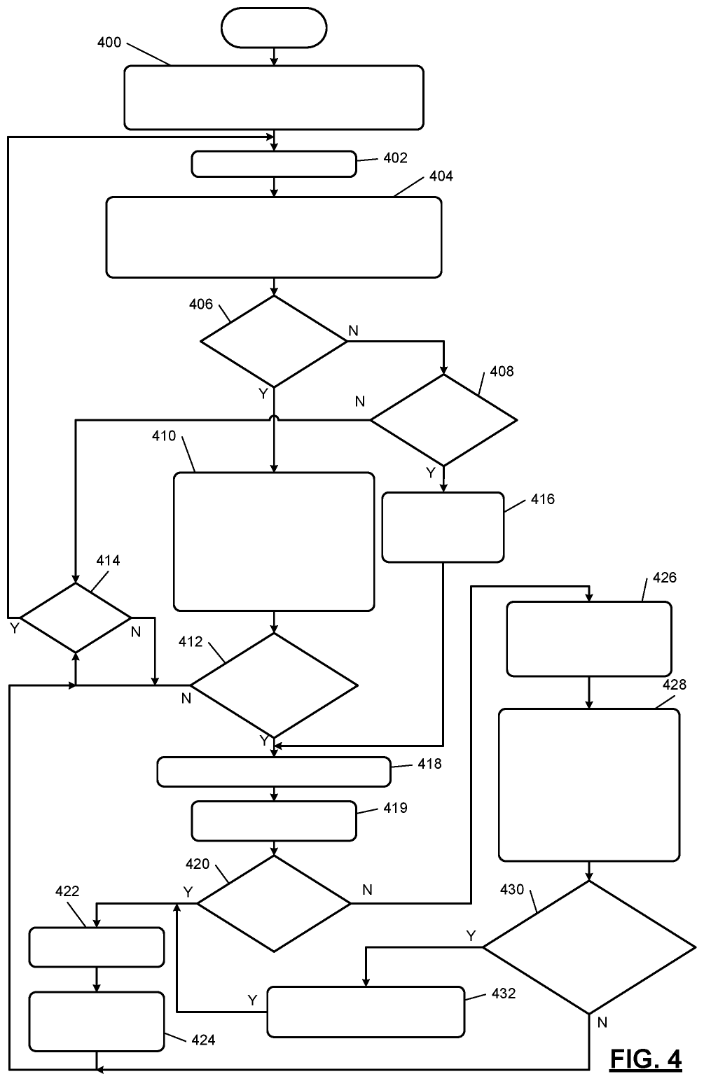

The driver mode signal 213 may indicate whether the driver has selected the auto eBurn mode or the manual eBurn mode. The auto eBurn mode includes the EDAM module 104 automatically engaging and disengaging the eBurn mode. The manual eBurn mode allows a driver to manually engage and disengage the eBurn mode. These modes are further described with respect to the method of FIG. 4.

The battery temperature signal 220 may indicate temperatures of the battery packs 196, the batteries of the battery packs, and/or the cells of the batteries. The battery temperature signal 220 may indicate an overall temperature of the battery packs 196.

The HVAC settings signal 221 may indicate an operating mode of the BEV HVAC system 152 including whether the BEV HVAC system 152 is operating in a heating mode or a cooling mode. The HVAC settings signal 221 may indicate fan speeds, valve positions, compressor speeds, etc.

The motor temperature signal 230 may indicate temperatures of the motors 178 of FIG. 1 and/or an average temperature of the motors 178. The motor speed signal 231 may indicate a speed of each of the motors 178 and/or an average speed of the motors 178.

The brake pressure signal 233 may indicate pressures applied by calipers of the brake system 140, a pressure of fluid within the brake system 140, pressures applied on rotors of the brake system 140, etc. The brake system 140 may be an electronic and/or hydraulic braking system.

The energy dissipation mode request signals 215, 224, 235, 241, 252 may request dissipation of electrical energy stored in the power sources 160 of FIG. 1. The requested dissipation power signals 216, 225, 236, 242, 253 may indicate a requested amount of energy to be dissipated. The real time energy dissipation signals 226, 237, 243, 254 may indicate an amount of energy currently being dissipated.

The energy dissipation capacity signals 227, 238, 244, 255 may indicate an amount of energy that the corresponding system is currently capable of dissipating. The amount of energy changes based on what devices are currently running and/or whether the currently running devices are being used for their intended purposes or are being used to burn energy. For example, if a device is currently running, then the amount of energy the device is able to dissipate in addition to the amount of energy already being consumed by the device is less than the total amount of energy the device would be able to dissipate if the device was in an idle state.

The driver notification signal 217 may indicate whether the eBurn mode is activated or deactivated. The driver notification signal 217 may indicate other status information and/or predictive information, such as: an amount of time for regenerative braking to be back to a certain percentage; SOC if driver overrides the eBurn mode at current time; etc. The driver override signal 218 may be a request from the driver to disengage (or stop operating in) the eBurn mode.

The arbitration and translation module 198 translates first messages in a first or standard language (or first protocol format) from the EDAM module 104 to second messages in other languages (or protocol formats) recognized by the systems 152, 150, 142, 202. This includes translating the mode and power command signals, which may be in the first protocol format, to command signals in the other protocol format, which are acceptable by the systems 152, 150, 142, 202. The translating process performed provides a versatile arrangement, where only the arbitration and translation module 198 is modified if systems are added to the EDAM system 101. The mode and power command signals are represented by arrow 260.

The command signals provided to the systems 152, 150, 142, 202 are represented by arrows 262, 264, 266, 268. The command signals may be i) high-level signals indicating amount of energy to be dissipated within a predetermined period of time and/or energy dissipation rates, or ii) low-level signals requesting that certain devices be activated, moved, adjusted, etc. When low-level signals are provided, the arbitration and translation module 198 may be controlling operation of devices (e.g., actuators) of the systems 152, 150, 142, 202. As an example, the command signals may request that the systems 152, 150, 142, 202 burn different amounts of energy based on i) the requestor(s) requesting energy dissipation, and ii) the capacities of the systems 152, 150, 142, 202 to burn energy.

FIG. 3 shows an example EDAM method. The following operation may be iteratively performed and is applicable to the examples of FIGS. 1-2 and 4. The operations may be performed by the EDAM module 104 of FIG. 1.

At 300, the EDAM module 104 receives energy dissipation mode request(s), requested dissipation power request(s), real time energy dissipation amounts, and energy dissipation capacities from requestors and dissipators. Requestors referring to systems requesting dissipation of energy and dissipators referring to systems dissipating energy due to the requested dissipation.

At 302, the EDAM module 104 calculates a total amount of energy to be dissipated over a determined period of time. This may include aggregating power requests and aggregating power burn achieved from dissipator devices and/or actuators. This is based on the amounts of power (or energy) requested to be burned as reported by requestors (or requesting systems) and the energy burning capacities reported by dissipators (or dissipating systems).

At 304, the EDAM module 104 prioritizes the one or more requests received based on the system requesting dissipation and/or other factors, such as temperature, pressure, speed, etc. The prioritization may be a safety ranking, where each system, actuator and/or device has a safety prioritization level. As an example, a brake system may rank higher (or be of higher priority) than another system that does not have a potential safety issue. Brake fade is a safety hazard that is to be avoided.

At 306, the EDAM module 104 assesses current capabilities of available dissipators to dissipate energy based on the energy dissipation capacity signals received from the systems (e.g., the systems 152, 150, 142, 202 of FIG. 2). The dissipators may refer to actuators and/or other devices of selected systems. The energy dissipation capacity signals may be from control modules, actuators and/or devices of the selected systems.

At 308, the EDAM module 104 generates statistical predictions of energy dissipation capabilities of the dissipators over time based on known characteristics of the systems and current vehicle parameters.

At 310, the EDAM module 104 provides dissipator requests, which may be based on a thermal model of the systems, actuators, and devices involved. An example of the thermal model is described below with respect to FIG. 4. This may include amounts of dissipation to be carried out by one or more dissipators. If performed by the EDAM module 104, the dissipator requests may indicate the amount of energy to be dissipated by each selected system and/or device. In an embodiment, the EDAM module 104 iterates proposed actuator requests until required constraints around dynamics are met.

At 312, the EDAM module 104 evaluates overall system model. This includes using the overall system model to comprehend interactions between the systems (e.g., BEV HVAC power expenditure may heat up battery packs and reduce overall SOC of the battery packs). This operation accounts for how energy dissipation by one system affects one or more other systems.

At 314, the EDAM module 104 provides predictions of dynamics of the systems and/or device performing the dissipation, which may be based on the thermal model. This is based on the interactions between the systems and/or devices.

During operations 310, 312, 314 calculations may be iteratively performed to determine the appropriate amount of energy to burn, such that the amount of energy stored at the end of the storage event of concern is maximized. For example, if the energy storage event is a regenerative braking event due to the vehicle 100 traveling on a declined road, then at the bottom of the declined road (or hill) the battery packs 196 are fully charged or charged to a maximum level. As another example, if a brake temperature is predicted to be greater than a predetermined threshold (e.g., 500° F.), then the EDAM module 104 may iteratively adjust the amount of energy to be dissipated until the predicted temperature is less than and within a predetermined range of the predetermined threshold.

At 316, the EDAM module 104 generate mode and power dissipation (or eBurn) command signals for dissipators and/or for arbitration and translation module 198.

At 318, the EDAM module 104 applies one or more hysteresis condition(s) to prevent eBurn commands from i) switching ON and OFF devices frequently, and/or ii) frequently transitioning between operating in a first state to burn energy to being in a state of not burning energy. The non-burning energy state may be an OFF state or an active state, where the device is consuming energy to perform an operation but is not burning energy to increase energy storage in the power sources 160. To prevent the EDAM system 101 from switching between activate and deactivate states too frequently, a hysteresis condition is applied defining the minimum time interval between status switches. As an example, this may include determine whether the time between ON and OFF is greater than a predetermined threshold, and if yes permitting the transition.

At 320, the EDAM module 104 sends mode and power dissipation commands to arbitration and translation module 198. Operation 302 may be performed subsequent to operation 320.

The above-described process is an iterative process. As an example, the process may be implemented such that the vehicle 100, when approaching a descent or a top of a mountain, performs the following operations. When for example the vehicle is 30 kilometers away from the descent, the vehicle 100 does not burn energy. As the vehicle 100 becomes closer and closer to the descent, the vehicle begins burning energy to make sure that the battery packs 196 have available store for the energy being produced due to regenerative braking when proceeding down the declined road.

FIG. 4 shows an example method for energy dissipation (or eBurn) enablement and disablement and is appliable to the examples of FIGS. 1-3. The following operations may be iteratively performed. Although the following operations are primarily described with respect to a requestor system being a brake system, the method may be modified for the requestor system being another requestor, such as a motor control system, a fuel cell system, or other requestor system. Similarly, the parameters monitored and evaluated for the other requestors to determine whether to enable burning of energy and/or to determine how much energy to burn may be different than stated below for example in operations 404, 410, 412.

At 400, the EDAM module 104 receives, an expected path of the vehicle 100, grade (or slope) of road, distance to be traveled for current road grade, and vehicle speed. The EDAM module 104 may receive other and/or additional parameters.

At 402, the EDAM module 104 initiates or resets a timer of the vehicle control module 102.

At 404, the EDAM module 104 receives and/or obtains from memory parameters including vehicle parameters, initial temperatures of brakes, initial SOC(s) of battery packs, coast regenerative braking capability, and battery regenerative storage limits. Coast regenerative braking refers to the ability of a motor to slow the vehicle when an accelerator is released and the recapturing of energy due to this braking. Rotational energy is converted to electrical energy and stored in the battery packs 196 of FIG. 1. Coast regenerative braking is considered as one of the model inputs. If for any reason, the regenerative braking capability is limited, leading to a non-feasible eBurn solution, a countermeasure may be performed, as described below. The energy assist application 134 may provide road data, such as slopes of road, distances to be traveled at each different slope, speeds traveled along sections of road having the indicated slopes, relationships between slopes and distances, relationships between vehicle speeds and distances, etc.

There are two operational eBurn modes: manual mode and auto mode.

Under auto mode, EDAM is automatically activated based on external factors, the drive mode, and a thermal model. A driver may terminate the auto mode at any time. At 406 and 408, the EDAM module 104 determines eBurn mode of operation this may be based on the state of the switch 199 or a stored setting and may include operating in the auto eBurn mode, the manual eBurn mode, or not operating in an eBurn mode. When in the auto eBurn mode, an active state of burning energy may be automatically enabled or disabled. When in the manual eBurn mode, an active state of burning energy may be manually enabled or disabled. At 406, the EDAM module 104 may determine whether to operate in the auto eBurn mode. If yes, then operation 410 is performed, otherwise operation 408 may be performed. At 408, the EDAM module 104 may determine whether to operate in the manual eBurn mode. If yes, then operation 416 is performed, otherwise operation 414 is performed.

At 410, the EDAM module 104 may predict brake temperatures, an amount of time the brakes will be at temperatures greater than a predetermined threshold (e.g., 500° F., 600° F., or other temperature), and/or other parameters indicative of the state of the brakes based on the thermal model.

An example of the thermal model is represented by equations 1-2, where P refers to the requested dissipation energy, e refers to a tracking area and/or range, k is a time constant, y refers to a real time factor, A is a tunable constant and is related to speed to make requested change. An example of the tracking area and/or range e is a brake rotor temperature limit minus a predicted maximum rotor temperature. When the predicted temperature is greater than the limit, then operations are performed to decrease the temperature. When the predicted temperature is smaller than the limit, then operations are performed i) to not exceed the limit, and/or ii) to maintain and/or increase the temperature up to the limit. The tunable constant λ may be calculated based on how far or close the parameter P is to an optimum value and how far or close the tracking area is from zero. The tunable constant A may be tuned to improve and/or provide a maximum level of performance. When γ(k)[e(k)−e(k−1)] is positive, then operations are performed to increase the requested dissipation energy. When γ(k)[e(k)−e(k−1)] is negative, then operations are performed to decrease the requested dissipation energy. The value P(k+1) may be iteratively calculated to provide a best value.

$$P ( k + 1 ) = P ( k ) + γ ( k ) [ e ( k ) - e ( k - 1 ) ] \qquad ( 1 )$$

$$γ ( k ) = λ \frac{P ( k ) - P ( k - 1 )}{e ( k - 1 ) - e ( k )} \qquad ( 2 )$$

The brake system thermal model is embedded in the implemented EDAM algorithm being executed to generate the requested energy dissipation which is passed to the EDAM module 104 for arbitration. The iterative calculation is applied to calculate the eBurn request based on the brake system thermal threshold (or brake rotor temperature threshold). Due to the characteristic of the iterative calculations, the algorithm is flexible to different brake system thermal thresholds. In an embodiment, when the denominator of equation 2 is zero or within a predetermined range of zero, the EDAM module 104 may refrain from making a change in a predicted parameter and/or the amount of energy to dissipate.

At 412, the EDAM module 104 determines whether the criteria for enabling the active state of burning energy is satisfied. As an example, the active state of burning energy may be enabled when a temperature of the brakes is greater than or is predicted to be greater than the predetermined threshold. In an embodiment, the active state may be enabled when an amount of time that the temperature of the brakes has or is predicted to be greater than the predetermined threshold exceeds a predetermined amount of time (e.g., 10 seconds, 30 seconds, or other amount of time). If yes, operation 418 is performed, otherwise operation 414 may be performed.

At 414, the EDAM module 104 may determine whether the timer has expired. If yes, operation 402 may be performed.

At 416, the EDAM module 104 may wait a predetermined period prior to performing operation 418. This prevents frequent switching ON and OFF of the active state of burning energy.

At 418, the EDAM module 104 operates in an active eBurn mode to dissipate (or burn) energy. This includes being in auto eBurn mode or the manual eBurn mode and actively burning energy, as described herein.

At 419, the EDAM module 104 indicates to the driver that the eBurn mode is enabled. This may be done, for example, via the infotainment module 106, a light on a dashboard of the vehicle 100, a light on the switch 199, etc. As an example, a message or a light may be provided on the display 120.

At 420, the EDAM module 104 determines whether an override request has been received. This may be received via the switch 199, the infotainment module 106, or via another device. The override request may be to disable eBurn operation. If yes, operation 422 may be performed, otherwise operation 426 may be performed.

At 422, the EDAM module 104 may transition out of the eBurn mode and disable burning of energy.

At 424, the EDAM module 104 may indicate to the driver that the eBurn mode is disabled. This may be done, for example, via the infotainment module 106, a light on a dashboard of the vehicle 100, a light on the switch 199, etc. As an example, a message or a light may be provided on the display 120. Operation 414 may be performed subsequent to operation 424.

At 426, the EDAM module 104 and/or the arbitration and translation module 198 may determine an energy dissipation requested amount based on the thermal model. If determined by the EDAM module 104, this amount may be indicated to the arbitration and translation module 198.

At 428, the EDAM module 104 predicts brake temperatures, amount of time brakes are at temperatures greater than the predetermined threshold, and/or other parameters based on thermal model and amount of energy requested to be dissipated. This may be referred to as a simulation to predict state of the brakes when dissipating the requested amount of energy. The energy requested to be dissipated is forwarded to the EDAM module 104 for further arbitration.

At 430, the EDAM module 104 determines whether criteria are satisfied for performing an overheat countermeasure. If yes, operation 432 may be performed, otherwise operation 414 may be performed.

At 432, the EDAM module 104 may perform a countermeasure. This may include generating a warning message and/or signal indicating that the brakes are overheating and/or are predicted to overheat. The vehicle control module 102 may autonomously pull the vehicle 100 over in a safe location and stop the vehicle 100 to allow the brakes to cool down. The vehicle control module 102 may direct the driver of the vehicle to pull the vehicle 100 over and stop the vehicle 100.

The examples described herein provide a high-level control architecture to manage engagement and disengagement of eBurn modes for different vehicle systems. The application of supervisory control via an EDAM module and the consideration of a brake system and/or other systems as energy dissipation requestors provides flexibility to add more energy dissipation requestors easily.

The examples described herein further include a look ahead strategy to trigger the eBurn mode. This strategy uses route information in conjunction with the brake system thermal model to predict a brake thermal estimate throughout a route being traveled. If the brake thermal estimate exceeds the thermal threshold, then the EDAM module calculates requested energy dissipation based on the brake system thermal model, which is an iterative calculation algorithm. The examples provide the strategy to prevent frequent mode switching to avoid potential physical system damage as well as a driver override strategy.

The examples provide a high-level algorithm to efficiently manage the eBurn mode for different systems. A high-level of SOC is maintained while burning some power from the battery packs as requested. The examples prevent a brake system from overheating during, for example, descents due to high SOC of the battery packs.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information, but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. An energy dissipation activation management (EDAM) system for a vehicle, the EDAM system comprising:
at least one requestor system configured to generate a request to burn energy stored in at least one battery pack of the vehicle;
at least one dissipator system configured to burn energy stored in the at least one battery pack; and
an EDAM module configured to receive the request, determine a status of the at least one requestor system, and based on the request and the status of the at least one requestor system, signal the at least one dissipator system to burn energy stored in the at least one battery pack.

2. The EDAM system of claim 1, wherein the burning of energy is defined as the dissipating of energy by the at least one dissipator system to reduce an amount of energy stored in the at least one battery pack to increase an amount of available storage in the at least one battery pack for energy generated by the at least one requestor system.

3. The EDAM system of claim 1, wherein the burning of energy is defined as the dissipating of energy from the at least one battery pack via the at least one dissipator system to increase available energy storage of the at least one battery pack and not to perform another vehicle operation via the at least one dissipator system.

4. The EDAM system of claim 1, wherein:
the at least one requestor system comprises at least one of a brake system and a motor control system; and
the EDAM module configured to determine a status of at least one of the brake system and the motor control system, and based on the status of the at least one of the brake system and the motor control system, signal the at least one dissipator system to burn energy stored in the at least one battery pack.

5. The EDAM system of claim 1, wherein the EDAM module is configured to operate in an auto energy burn mode or a manual energy burn mode.

6. The EDAM system of claim 1, wherein the EDAM module is configured to determine whether an override signal has been received, and in response to receiving the override signal, cease operating in an energy burn mode.

7. The EDAM system of claim 1, wherein the EDAM module is configured to:
determine an amount of energy to dissipate to prevent overheating of a component of the at least one requestor system;
based on the determined amount of energy to dissipate, predict whether the component will overheat; and
in response to determining that the component is expected to overheat, performing a countermeasure to prevent the component from overheating.

8. The EDAM system of claim 1, wherein the EDAM module is configured to determine the status of the at least one requestor system based on a thermal model, and enable operation in an energy burn mode in response to the status.

9. The EDAM system of claim 1, further comprising an arbitration module, wherein:
the EDAM module is configured to determine an amount of energy to burn;
the at least one dissipator system comprises a plurality of dissipator systems;
each of the plurality of dissipator systems generating an energy dissipation capacity signal indicating an amount of energy the corresponding dissipator system is capable of burning; and
the arbitration module is configured, based on the amount of energy to burn and the energy dissipation capacity signals, determine how much energy each of the plurality of dissipator systems is to burn and control each of the plurality of dissipator systems to burn that determined amount of energy.

10. The EDAM system of claim 1, further comprising an arbitration module, wherein:
the EDAM module is configured to determine an amount of energy to burn;
the at least one dissipator system comprises a plurality of dissipator systems;
each of the plurality of dissipator systems generating an energy dissipation capacity signal indicating an amount of energy the corresponding dissipator system is capable of burning; and
the arbitration module is configured, based on the amount of energy to burn and the energy dissipation capacity signals, determine how much energy each of the plurality of dissipator systems is to burn and instruct each of the plurality of dissipator systems to burn that amount of energy.

11. The EDAM system of claim 1, further comprising a translation module, wherein:
the at least one dissipator system comprises a plurality of dissipator systems;
the EDAM module is configured to generate a command signal according to a first protocol format and indicative of an amount of energy to burn; and
the translation module is configured to translate the command signal into a plurality of commands respectively for the plurality of dissipator systems, the plurality of commands being in a plurality of different protocol formats acceptable by the plurality of dissipator systems.

12. The EDAM system of claim 1, wherein:
the at least one dissipator system comprises a plurality of dissipator systems; and
the EDAM module is configured to account for interactions between the plurality of dissipator systems, and based on the interactions, determine amounts of energy to be burned by the plurality of dissipator systems, and directly or indirectly signal the plurality of dissipator systems to burn the determined amounts of energy.

13. The EDAM system of claim 1, wherein the EDAM module is configured to perform an iterative calculation to obtain the energy requested to burn.

14. The EDAM system of claim 1, wherein the EDAM module is configured to apply a hysteresis condition to prevent frequent switching in and out of an energy burning mode.

15. A method of operating an energy dissipation activation management (EDAM) system of a vehicle, the method comprising:
generating via at least one requestor system a request to burn energy stored in at least one battery pack of the vehicle;
burn energy via stored in the at least one battery pack via at least one dissipator system;
determining a status of the at least one requestor system; and
based on the request and the status of the at least one requestor system, signaling the at least one dissipator system to burn energy stored in the at least one battery pack.

16. The method of claim 15, further comprising:
determining an amount of energy to dissipate to prevent overheating of a component of the at least one requestor system;
based on the determined amount of energy to dissipate, predicting whether the component will overheat; and
in response to determining that the component is expected to overheat, performing a countermeasure to prevent the component from overheating.

17. The method of claim 15, further comprising:
determining the status of the at least one requestor system based on a thermal model; and
enabling operation in an energy burn mode in response to the status.

18. The method of claim 15, further comprising:
determining an amount of energy to burn, wherein the at least one dissipator system comprises a plurality of dissipator systems;
generating via each of the plurality of dissipator systems an energy dissipation capacity signal indicating an amount of energy the corresponding dissipator system is capable of burning; and
based on the amount of energy to burn and the energy dissipation capacity signals, determining how much energy each of the plurality of dissipator systems is to burn and controlling each of the plurality of dissipator systems to burn that determined amount of energy.

19. The method of claim 15, further comprising:
determining an amount of energy to burn, wherein the at least one dissipator system comprises a plurality of dissipator systems;
generating via each of the plurality of dissipator systems an energy dissipation capacity signal indicating an amount of energy the corresponding dissipator system is capable of burning; and
based on the amount of energy to burn and the energy dissipation capacity signals, determining how much energy each of the plurality of dissipator systems is to burn and instructing each of the plurality of dissipator systems to burn that amount of energy.

20. The method of claim 15, further comprising:
generating a command signal according to a first protocol format and indicative of an amount of energy to burn;
translating the command signal into a plurality of commands respectively for a plurality of dissipator systems, the plurality of commands being in a plurality of different protocol formats acceptable by the plurality of dissipator systems, wherein the at least one dissipator system comprises the plurality of dissipator systems;
accounting for interactions between the plurality of dissipator systems; and
based on the interactions, determining amounts of energy to be burned by the plurality of dissipator systems, and directly or indirectly signaling the plurality of dissipator systems to burn the determined amounts of energy.
